(19) United States
(12) Patent Application Publication
(10) Pub. No.: US 2005/0279716 A1
(43) Pub. Date: Dec. 22, 2005

(54) WATER FILTER MODULE HANDLING APPARATUS

(75) Inventor: Michael JACKMAN, Hertfordshire (GB)

Correspondence Address: LAHIVE & COCKFIELD, LLP., 28 STATE STREET, BOSTON, MA, 02109, US

(73) Assignee: VEOLIA WATER UK PLC, London (GB)

(21) Appl. No.: 10/710,148

(22) Filed: Jun. 22, 2004

(51) Int. Cl. B01D 35/00

(52) U.S. Cl. 210/791; 210/232; 210/407; 210/541

(57) ABSTRACT

A water filter module handling apparatus includes a water filter module carriage support means and a water filter module carriage means that is movable between a module receiving position neighboring a module housing and a module transport position. A water filter module is extracted by locating the water filter module carriage means next to the open end of a water filter module housing, extracting the water filter module from the housing onto the carriage means and moving the conjoined water filter module and water filter module carriage means to a second position.

### FIELD OF THE INVENTION

The present Application relates to apparatus for supporting a water filter module during extraction and/or insertion into a module housing, and associated method.

### BACKGROUND OF THE INVENTION

Water treatment plants such as that for Three Valleys Water at Clay Lane in Bushey, Hertfordshire, England, increasingly use ultrafiltration as part of the treatment process. Generally this involves passing the water to be treated through fiber membranes. Fiber membrane filtration is a well developed method which involves the use of a large number of hollow tubular micro-porous fibers, each fiber being adapted to allow water to permeate through the pores along the length of the fiber, either from their exterior to the interior, or vice versa. The pores are generally of a sub-micron size, and exclude impurities from the filtrate.

A currently common method of providing the fibers is by housing many thousands of them bundled together and encased in a shell to form a “module”. The shell is usually cylindrical, and the fibers extend longitudinally of the shell with the ends of the shell being sealed. Such modules are typically 1.5 m long and 20 cm in diameter, and can involve 10,000 or so fibers.

In practice, a number of modules, typically two or four, are installed in a series along one cylindrical housing. A multitude of housings, such as twelve, are then brought together in one skid in the form of two racks of six. Typically around the housings is a significant array of pipes, valves, taps etc., required to interconnect all the housings.

A medium or large water treatment plant may comprise several hundred or thousand modules, each module containing may thousands of fibers. The failure of any one fiber is detrimental to the integrity of the treatment process, such that modules are generally tested at least daily and if a fault is detected in any module, this must be repaired or replaced.

A typical 1.5 m module generally weighs, in a dry state, about 20 kg. However, a wet module, i.e. one that has been in use but must now be removed will have a substantial weight of water therein, as well as being “half filled” with water from alignment of the inlet and outlet pipes of the housing. This wet weight typically exceeds 20 kg, and often is much more.

To remove a wet module from a housing presently requires three to six men to physically man-handle the module out and away from the housing. The effort is doubled where the housing is located some way above the ground, including any housing typically above lm from the ground. Along with the spillage and egress of water, the job of removing potentially faulty modules is not pleasant. The array of pipes, etc. adds to the awkwardness and discomfort of removing modules from their housings.

In a treatment plant such as Clay Lane where there are approximately 1600 modules, the regularity of faults in modules leads to a never-ending module handling effort.

### BRIEF SUMMARY OF THE INVENTION

It is an object of the present invention to obviate the above disadvantages.

Thus, according to one aspect of the present invention, there is provided a handling apparatus for supporting a water filter module comprising a module carriage means and a module carriage support means, the carriage means being moveable between a module receiving position neighboring a module housing, and a module transport position.

The apparatus significantly reduces the manual input required for the module removing operation, which could then be carried out by a single operator.

The module carriage means preferably has a module holding cradle. The cradle is preferably an elongate open channel, more preferably having a general Vcross-sectional shape.

The carriage means may include a module transport-holding means such as one or more straps or belts. The carriage means may also include running and/or friction means such as belts, strips, etc. to assist with the interaction between the module and the carriage means.

In one embodiment of the present invention, the carriage means comprises two or more parts, preferably one of which is moveable between contracted and extended positions relative to the or one other part. The two or more parts preferably include interlocking means to secure the relationship between the parts at their extended and/or contracted positions.

The module carriage support means of the present invention preferably is also moveable in one or more planes, including rotational and/or vertical movement.

The support means is preferably transportable. This may be self-propelled transportation, or may be transportation by a separate apparatus or vehicle such as a load-bearing truck. In this latter arrangement, there is preferably securing means between the support means and the separate vehicle to secure the two parts together during use.

According to a second aspect of the present invention, there is provided a method of extracting a water filter module from a module housing comprising the steps of: locating the module carriage means of an apparatus as hereinbefore described next to the open end of the module housing; extracting the module from the housing onto the carriage means; and moving the conjoined module and carriage means to a second position.

The present invention can equally be used for loading or unloading a module from a module housing. However, it is recognized that unloading a wet module is the harder process, and thus the invention is more commonly directed thereto.

The present invention may have any suitable size, shape or design suitable to maneuver around the housing array of pipes, etc. Typically, the housings are closely packed and aligned within the water treatment plant, thus requiring careful alignment and use of the present invention within the working area confine.

The apparatus of the present invention extends to handling modules of any size, shape and design. The apparatus may also handle the loading and/or unloading and/or transportation of more than one module at a time, depending upon the working area around the skids.

### BRIEF DESCRIPTION OF THE DRAWINGS

An embodiment of the present invention will now be describe by way of example only, and with referenced to the accompanying drawings in which;

FIG. 1 is a photograph of part of a water treatment plant;

FIGS. 2a, 2b and 2c are side, plan and end views respectively of a handling apparatus according to one embodiment of the present invention;

FIG. 3 is a diagrammatic perspective view of the apparatus in FIGS. 2a-2c in use;

FIGS. 4 to 6 are photographs of the apparatus in FIGS. 2 and 3 on a pallet truck; and

FIGS. 7 to 10 are photographs of the apparatus in FIGS. 2 and 3 on a pallet truck, and with a water filter module therewith.

### DETAILED DESCRIPTION OF THE INVENTION

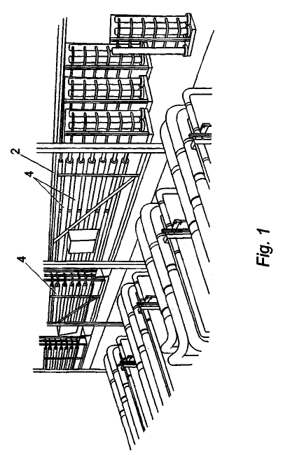

Referring to the drawings, FIG. 1 shows a typically layout of a number of ultrafiltration skids 2 within a water treatment plant. Each skid 2 has twelve (two vertical rows of six) housings 4.

Each housing 4 has four water filter modules 6. Around the skid 2 can be seen the associated pipework required.

Each module 6 is 1.5 m long, and this is not much less that the inter-skid distance. Thus, removal of each module 6 requires careful extraction from each housing 4. Because the modules 6 are close fitting in the housings 4, each module 6 must be removed directly outwardly from the alignment of the housing 4 through the associated pipework, and into the inter-skid area. As can be seen from FIG. 1, there is little room for this to be done. Combined with the fact that the housing 4 can be 2 m above ground, i.e. ‘head-height’, and weigh well over 20-25 kg and be wet and therefore extremely slippery, it can be seen that removal of modules 6 by hand is an extensive operation, typically requiring 3-4 people.

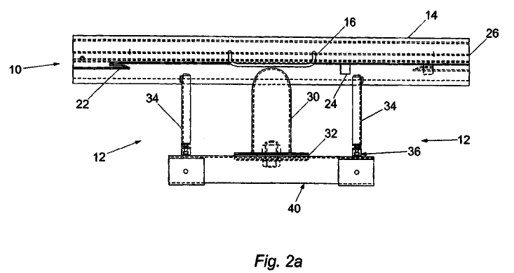

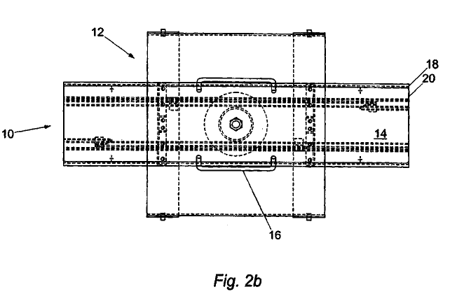

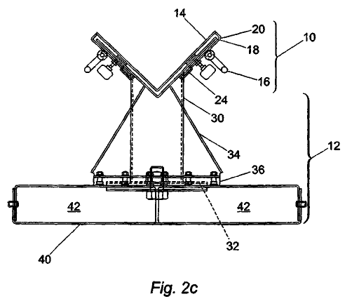

FIGS. 2a-2c show a handling apparatus for supporting a water filter module 6 comprising a module carriage means 10 and a module carriage support means 12.

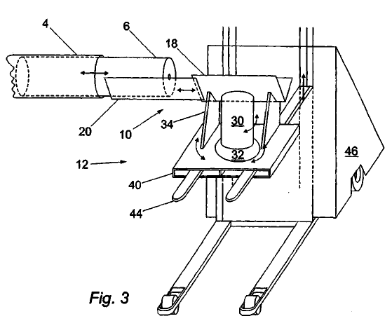

The module carriage means 10 has an elongate cradle 14, having a general V cross-sectional shape. The cradle 14 includes two handles 16, one on each underside. The cradle 14 has two parts, a fixed lower guide 18 and a top sliding guide 20. The upper sliding guide 20 is moveable between a first contracted position on top of the fixed guide 18 (as shown in FIGS. 2a-2c), and a second extended position as shown in FIG. 3. The two guides 18, 20 have interlocking lugs 22 and hooks 24 which interlock when the top guide 20 is in its extended position to secure the two guides 18, 20 together.

The top guide 20 includes two PTFE strips 26 along the inside of each part of the “V”. These strips 26 serve two purposes. Firstly, to prevent damage of the module shell against the top guide 20. Secondly, to assist friction between the module 6 and the top guide 20 during movement therebetween, especially when extracting a wet module which is slippery therebecause.

The cradle 14 is supported by a central support tube 30 mounted on a swivel plate 32, and two side support walls 34. The base of each side support wall 34 is a wear pad 36 made of a material well known in the art such as PTFE.

The central tube 30 and support walls 34 are supported on a base frame 40. The base frame 40 has two sleeve portions 42 adapted to receive the tines 44 of a pallet truck 46 as shown in FIG. 3.

The swivel plate 32 allows rotation of the cradle 14 relative to the base 40, both to assist in aligning the cradle 14 with a housing 4, and also to rotate a loaded module 6 on the cradle 14 to a suitable transportation or other-handling position. The support walls 34 are moveable on the top of the base 40 frame via the wear pads 36.

The present invention is typically brought into use when a fiber failure has been detected in a housing 4. To detect which fiber has failed, all four modules 6 must be removed and individually tested from the housing 4. Once the associated end plate have been removed from the housing 4, the pallet truck 46 is maneuvered between the skids 2 in a manner to align the cradle 14 of the apparatus of the present invention along the longitudinal axis of the housing 4. Typically this will involve positioning of the pallet truck 46 in such a manner that once maneuvered, only vertical movement of its tines 44 is required to align the cradle 14 with each of the six vertically-aligned housings 4 in a rack of a skid 2.

Once aligned, the top guide 20 of the cradle 14 is slidingly extended without the bottom guide 18, such that the distal end of the top guide 20 is adjacent the open end of the housing 4 (FIG. 3). Then, a rod or similar instrument (not shown) is located in the central hole of the module 6, in order to extract the module 6 out of the housing 4, and onto the extended top guide 20. Once the module 6 is free of the housing 4, the top guide 20 is slidingly moved to its contracted position such that the module 6 is free of the associated pipework between the end of the housing 4 and the skid 2. The housing 6 can then be transported to a fiber testing bath, either manually once all its water has drained away, or using the pallet truck.

Loading of a module 6 into a housing 4 is by reverse operation to the above.

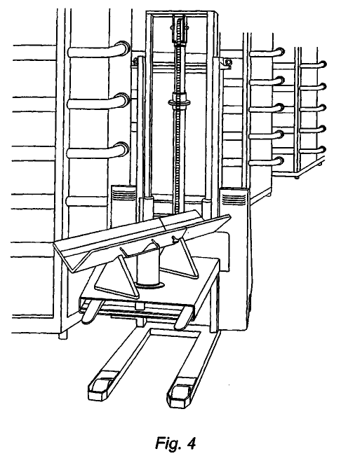

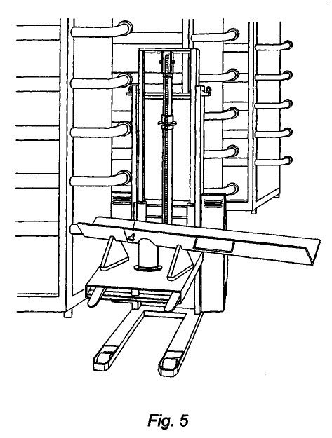

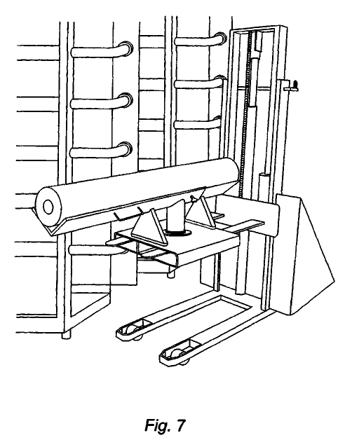

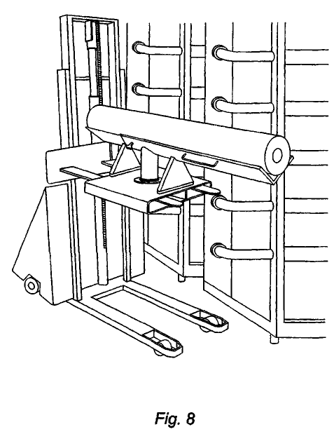

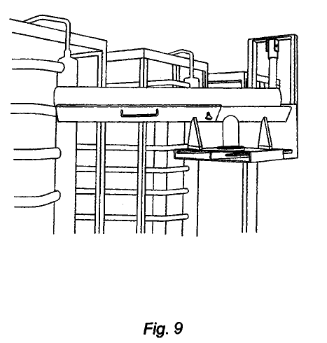

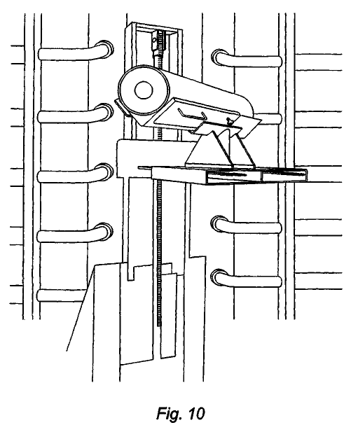

FIGS. 4 to 10 are photographs of the handling apparatus shown in FIGS. 2a to 2c and 3. FIGS. 7 to 10 show the apparatus holding a water filter module 6. The photographs show the apparatus in various different orientations, including heights and directions (in relation to the pallet truck). The photographs also show the upper and lower guides of the cradle in contracted (FIG. 4) and extended (FIGS. 5 to 10) positions.

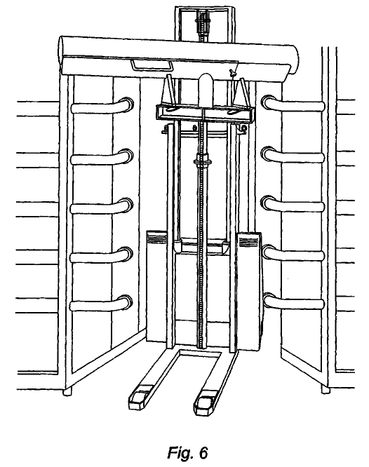

FIGS. 6, 9 and 10 in particular show the benefit of the present invention in being able to provide a cradle which is accessible around and in between the pipework around the skid in front of each housing.

All the above operations can be carried out by one person, possibly with assistance on higher housings, as it is the handling apparatus that is bearing the weight of the modules, especially when wet.

The present invention provides a simple and effective apparatus for handling heavy and usually wet modules, most especially their unloading from a relatively high height. The reduction in manhandling is significant, providing significant overall reduction in manual input in a water treatment plant requiring daily module testing.

1. A handling apparatus for supporting a water filter module comprising a module carriage means and a module carriage support means, the carriage means being moveable between a module receiving position neighboring a module housing, and a module transport position.

2. The handling apparatus of claim 1 wherein the module carriage means has a module holding cradle.

3. The handling apparatus of claim 2 wherein the cradle is an elongate open channel having a general V-cross-sectional shape.

4. The handling apparatus of claim 1 wherein the carriage means comprises two or more parts, one of which is moveable between contracted and extended positions relative to the or one other part.

5. The handling apparatus of claim 2 wherein the carriage means comprises two or more parts, one of which is moveable between contracted and extended positions relative to the or one other part.

6. The handling apparatus of claim 3 wherein the carriage means comprises two or more parts, one of which is moveable between contracted and extended positions relative to the or one other part.

7. The handling apparatus of claim 1 wherein the module carriage support means is moveable in one or more planes, including rotational and/or vertical movement.

8. The handling apparatus of claim 2 wherein the module carriage support means is moveable in one or more planes, including rotational and/or vertical movement.

9. The handling apparatus of claim 3 wherein the module carriage support means is moveable in one or more planes, including rotational and/or vertical movement.

10. The handling apparatus of claim 1 wherein the apparatus is self-propelled.

11. The handling apparatus of claim 2 wherein the apparatus is self-propelled.

12. The handling apparatus of claim 3 wherein the apparatus is self-propelled.

13. A method of extracting a water filter module from a module housing comprising the steps of:
locating the module carriage means of an apparatus as hereinbefore described next to the open end of the module housing;
extracting the module from the housing onto the carriage means; and
moving the conjoined module and carriage means to a second position.
